(19) United States
(12) Patent Application Publication
(10) Pub. No.: US 2006/0121330 A1
(43) Pub. Date: Jun. 8, 2006

(54) Method for forming a separator plate for a fuel cell, and separator plate

(75) Inventors: Joost Freek Cees-Jan Martijn Reijerse, Haarlem (NL); Bart Daniel Carleer, Winterswijk (NL); Maria Gemma Othilde Klaassen, Purmerend (NL)

Correspondence Address: STEVENS DAVIS MILLER & MOSHER, LLP, 1615 L STREET, NW, SUITE 850, WASHINGTON, DC, 20036, US

(73) Assignee: Corus Technology BV, Ijmuiden (NL)

(21) Appl. No.: 10/534,691

(22) PCT Filed: Nov. 13, 2003
(86) PCT No.: PCT/NL03/00799

§ 371 Date: Nov. 2, 2005

(30) Foreign Application Priority Data
Nov. 15, 2002 (NL) 1021932

(51) Int. Cl. H01M 8/02; B21C 37/02; B21D 13/00

(52) U.S. Cl. 429/38; 428/595; 72/379.6

(57) ABSTRACT

The invention relates to a method for forming a separator plate for a fuel cell, which separator plate has a number of projecting sections. According to the invention, the projecting sections in the separator plate are formed by a metal plate being pressed onto a die having a number of recessed sections with the aid of a pressurized fluid or by the die being pressed onto the metal plate supported by pressurized fluid, the recessed sections in the die corresponding to the projecting sections which are to be formed in the metal plate, in order to obtain the separator plate having the projecting sections. The invention also relates to a separator plate produced using the method.

The invention relates to a method for forming a separator plate for a fuel cell, which separator plate has a number of projecting sections. The invention also relates to a separator plate.

Separator plates are used in a fuel cell. One example of a fuel cell is a PEM fuel cell, which is used to have hydrogen and oxygen reaction to generate electricity, with the only waste product being formed being water. Consequently, PEM fuel cells are very environmentally friendly. A PEM fuel cell comprises a number of membranes (polymer electrolyte membranes), which on both sides are provided with a catalyst, so that the hydrogen can react with the oxygen. Each cell can only generate a voltage of approximately 0.7 volt, and consequently a large number of cells are required in order to drive a car, for example. At least one separator plate must be present between each pair of membranes, inter alia in order to keep the hydrogen separate from the oxygen and in order to create supply and discharge passages for the hydrogen, the oxygen and the water. Therefore, a fuel cell will contain at least as many separator plates as there are membranes.

High demands are imposed on the separator plates. They have to be able to withstand corrosion with respect to the reaction product water which is formed, but also have to be resistant to hydrogen. In view of the large number of separator plates required, the separator plates have to be thin and lightweight, so that a fuel cell does not become too large and too heavy, and it must also be possible for the separator plates to be produced at low cost in order to make fuel cells economically attractive.

In the first instance, separator plates were made from solid carbon plates in which slots were formed, for example by milling. Currently, separator plates for fuel cells are also made from metal, for example from stainless steel, into which grooves are pressed in order to obtain the projecting sections, for example by deep-drawing or pressing.

It is an object of the invention to provide a method for producing separator plates at low cost.

Another object of the invention is to provide a method with which separator plates can be produced in a simple way.

Yet another object of the invention is to provide a method which can be used to produce improved separator plates.

An additional object of the invention is to provide separator plates which are less expensive than separator plates produced using known techniques.

It is also an object of the invention to provide improved separator plates.

A first aspect of the invention provides a method for forming a separator plate for a fuel cell, which separator plate has a number of projecting sections, in which method the projecting sections in the separator plate are formed by a metal plate being pressed onto a die having a number of recessed sections with the aid of a pressurized fluid or by the die being pressed onto the metal plate supported by pressurized fluid, the recessed sections in the die corresponding to the projecting sections which are to be formed in the metal plate, in order to obtain the separator plate having the projecting sections.

A number of advantages over conventional deep-drawing or pressing are obtained by forming separator plates with the aid of this method, also referred to by the term hydroforming. Hydroforming creates a relatively uniform material elongation in the metal plate, with the result that the projecting sections of the separator plate can be of a relatively great depth. There is no need for mechanical deformation of the metal plate in this case. The surface of the metal plate is not damaged by the contact with the fluid, whereas there is a risk of it being damaged when mechanical deformation is used. The fluid selected is usually water, oil or a water/oil mixture. However, it is also possible for a polymer, a lacquer, an electrolyte, a glass or a salt to be selected for the fluid. This makes it possible for the fluid also to be used as a coating or as a pretreatment prior to the coating operation.

It is preferable for the pressure of the fluid to be selected to be sufficiently high for the metal plate to be pressed onto the die over its entire surface. This allows the shape of the separator plate to be imparted to the metal plate. Mechanical deformation will always be subject to some degree of spring-back.

It is preferable for a calibration pressure to be selected for the pressure of the fluid. In this context, the term calibration pressure is to be understood as meaning a pressure at which the metal plate is subject to such a high load that the residual stresses largely disappear, with the result that the separator plate accurately acquires the shape of the recesses in the die with the recesses therein.

According to a preferred embodiment, the pressure of the fluid is selected to be between 250 and 6000 bar (25 and 600 MPa). The pressure selected will of course be dependent on the thickness of the metal plate and on the shaping of the projecting sections in the metal plate, in particular the depth of the projecting sections with respect to their width and the roundings which have to be formed. In addition, the pressure selected will depend on the type of material which is to be deformed; some materials can be deformed at a pressure of between 500 and 1000 bar (50 and 100 MPa), while for other materials a pressure of at least 1000 bar (1000 MPa) and preferably at least 1500 bar (150 MPa) or even at least 2000 bar (200 MPa) is desired.

According to one embodiment of the method, the metal plate is first of all placed against the die, and the metal plate is then pressed onto the die by the pressurized fluid. This is a simple embodiment of the method in which the metal plate can be supplied as a coil, with the result that the separator plates can be produced in a continuous process.

According to another embodiment of the method, the metal plate is first placed under a preliminary pressure by the fluid, and then the die is pressed onto the metal plate and the fluid is pressurized. Initially placing the metal plate under a preliminary pressure causes the metal plate to undergo initial preliminary elongation, with the result that a greater length of the plate is obtained, before it is brought into contact with the die, with the result that more uniform elongation is obtained in the separator plate and the shape of the die can be followed more successfully.

According to an advantageous embodiment, a membrane is placed between the metal plate and the fluid, preferably a membrane provided with a coating in order to simultaneously coat the metal plate. The membrane prevents contamination of the separator plate. The simultaneous application of a coating is advantageous for situations in which a coating on the separator plate is desired.

The coating may consist of a metallic, organic or inorganic coating or a combination thereof.

It is preferable for the metal plate selected to be a plate made from a readily deformable metal, such as low-carbon steel, ultralow-carbon steel, aluminium, stainless steel or titanium. These metals are readily deformable and can be used as metal for separator plates.

In this case, the metal preferably has a deformability corresponding to a uniform elongation at break of at least 20%, in accordance with the ASTM E6 standard for tensile tests for plate. With this deformability, it is possible to obtain the desired shape of separator plates with the aid of hydroforming, for example to obtain a depth with respect to the width of the projecting sections which is greater than that which can be achieved with the aid of mechanical deformation.

According to a preferred embodiment of the method, the plate is at room temperature during the pressing operation. This means that the method can be carried out without the need for special measures in order to heat the metal plate while the method is being carried out.

According to another preferred embodiment, the plate is at an elevated temperature during the pressing operation, for example 500-1000° C. for carbon steel, 100-550° C. for aluminium and 600-1300° C. for stainless steel. Although this makes the method less simple to carry out, since the plate and therefore also the die and the fluid have to be heated while the method is being carried out, the metal plate is, however, more deformable as a result of having been heated, and consequently the depth of the recesses with respect to their width can be increased. The best results are obtained using the preferred values given for the temperature.

It is preferable for the thickness of the metal plate prior to the deformation to be selected to be between 0.05 and 0.40 mm, more preferably between 0.05 and 0.20 mm. This thickness of the metal plate allows successful hydroforming, while the depth of the projecting sections of the separator plates can be made sufficiently deep. A thickness of between 0.05 and 0.20 mm is preferred in order to make the separator plates thinner and more lightweight.

According to a preferred embodiment of the method, the metal plate is cut into a desired shape and size at the same time as the projecting sections are being pressed into the metal plate. This is practical in particular if the metal plates are supplied as strip material, since in this way the separator plates can be cut to the desired size at the same time.

A second aspect of the invention provides a separator plate having a number of projecting sections, produced with the aid of the method in accordance with the first aspect of the invention, the separator plate being formed from a readily deformable metal plate, such as a plate made from low-carbon steel, ultralow-carbon steel, aluminium, stainless steel or titanium.

The separator plate produced using the method described above can be used in particular if the metal plate from which it is made is readily deformable, since it is then possible to achieve a greater depth with respect to the width of the projecting sections than is possible using mechanical deformation methods.

The metal preferably has a deformability corresponding to a uniform elongation at break of at least 20%, in accordance with the ASTM E6 standard for tensile tests for plate. Consequently, the metal plate has a deformability which is in any event sufficient to acquire the desired depth with respect to the width of the projecting sections with the aid of hydroforming.

According to a preferred embodiment, the thickness of the separator plate is between 0.05 and 0.40 mm, preferably between 0.05 and 0.20 mm, at the undeformed sections of the plate. The separator plates having these thicknesses can successfully be formed with the aid of hydroforming and satisfy the requirements imposed on the use of separator plates in a fuel cell.

It is preferable for the rounding radius of the transitions in the plate to be at least equal to the thickness of the undeformed sections of the plate. If the rounding radius were to be selected to be lower than this thickness, a much higher fluid pressure would be required in order to force the plate into an angle with a rounding radius of this nature.

According to a preferred embodiment, the projecting sections have a repeating pattern with a pitch w and a depth d, where 0.03<d/w<1.2, preferably 0.1<d/w<0.5, more preferably 0.2<d/w<0.5 if the plate is deformed at room temperature, and where 0.03<d/w<2.4, preferably 0.2<d/w<1.0 and more preferably 0.4<d/w<1.0 if the plate is deformed at high temperature. A ratio of this nature between the depth and the pitch of the repeating projecting sections is eminently possible if the separator plates are produced with the aid of hydroforming, while in particular the preferred values are not readily possible with the aid of mechanical deformation methods.

The invention also relates to a separator plate having a number of projecting sections, in which the projecting sections are surrounded by a substantially planar section of the separator plate, the projecting sections having a substantially repeating pattern with a pitch w and a depth d, where 0.25<d/w<2.4. The surrounding section may, for example, be planar apart from a feed passage and a discharge passage, through which hydrogen, oxygen and water can be supplied and discharged. The ratio between the pitch w and the depth d is such that it cannot be made using the conventional mechanical production methods. The thickness of the plate is in this case preferably between 0.05 and 0.40 mm, more preferably between 0.05 and 0.20 mm, at the undeformed sections of the plate.

The invention will be explained on the basis of an exemplary embodiment and with reference to the appended drawing, in which:

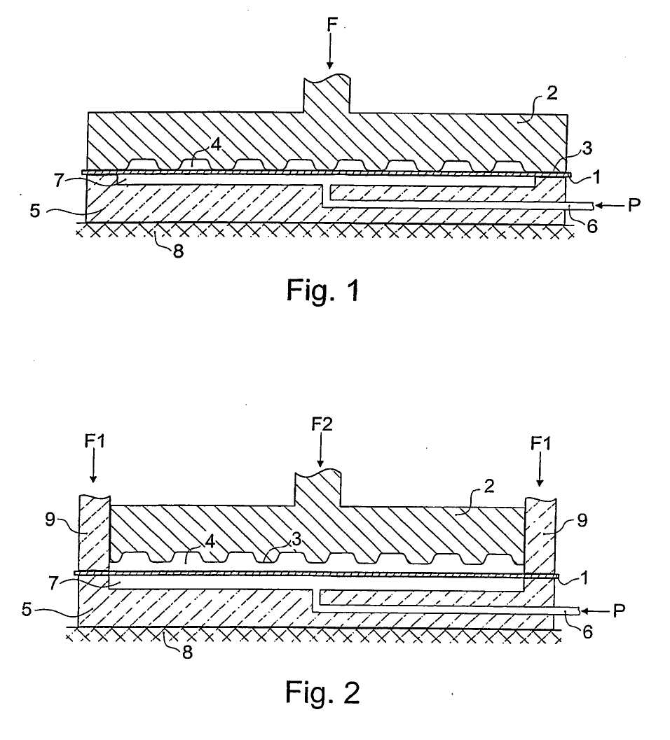

FIG. 1 diagrammatically depicts a first device for carrying out the method according to the invention.

FIG. 2 diagrammatically depicts a second device for carrying out the method according to the invention.

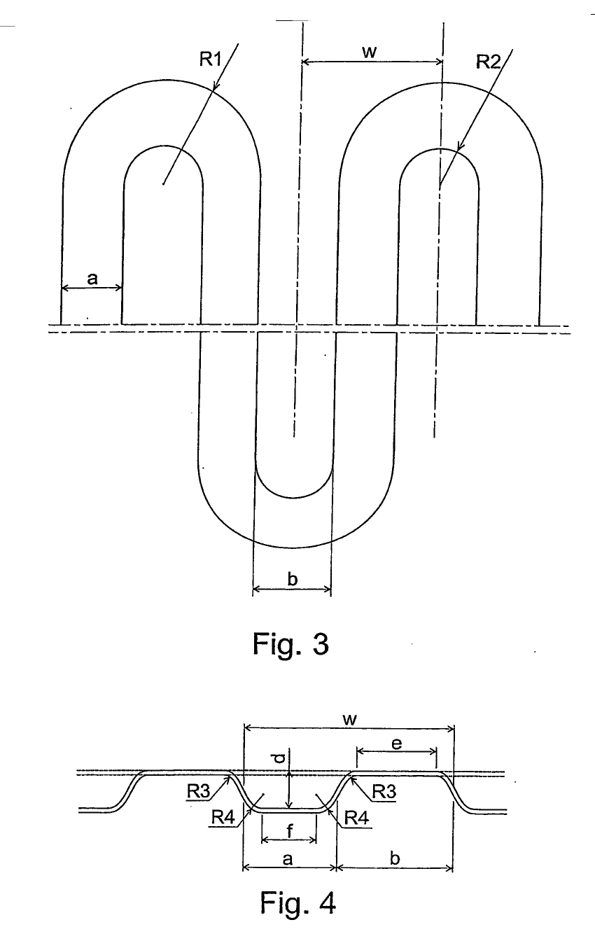

FIG. 3 diagrammatically depicts a pattern for projecting sections in a separator plate, produced in accordance with the invention.

FIG. 4 shows a cross section through the separator plate shown in FIG. 3, not to scale.

FIG. 1 shows a device for the hydroforming of a metal plate 1 to form a separator plate. The metal plate 1 is positioned between a top die 2, which is provided with recessed sections 4 in a bottom surface 3, by means of which the die 2 is pressed onto the plate 1 by a force F, and a bottom die 5, which is provided with a recess 7 in its central section for fluid which can be supplied under a pressure P through a line 6 which runs through the bottom die 5. The top die is pressed onto the plate 1 with a force F which is such that it is impossible for any fluid to leak out of the device; if appropriate, separate seals (not shown) may be provided for this purpose. At the same time, the force F has to be high enough to withstand the force on the metal plate 1 which is generated by the pressure P in the fluid in the recess 7. The pressure P is selected to be sufficiently high for the plate 1 to be deformed and to come to bear against the walls of the recesses 4 in the top die 2. The level of the pressure P is dependent on the thickness of the plate 1 and the shape of the recesses 4, and also on the material selected. The pressure is preferably such that there is little or no spring-back of the deformed sections in the separator plate after the pressure P has been removed. The fluid used is usually water, oil or a water/oil mixture.

FIG. 2 shows another device for hydroforming a metal plate 1 to form a separator plate. This device is largely identical to the device shown in FIG. 1, except that the top die 2 can move between a clamping die 9. This clamping die 9 is pressed onto the plate 1 with a force F1 which is such that it is impossible for any fluid to leak out of the device, while the top die 2 is not yet being pressed onto the plate 1. This enables the plate 1 to be placed under a preliminary pressure with the aid of fluid in the recess 7 in the bottom die 5, with the result that the plate 1 will undergo preliminary elongation and will adopt a convex position, resulting in a greater length of the plate, so that the plate can more successfully follow the shape of the die. Then, the top die 2 is moved downwards and the final pressure P is applied, with the result that the plate 1 is deformed and comes to bear against the walls of the recesses 4 in the top die 2. The preliminary elongation of the plate 1 results in a more uniform elongation in the metal plate.

A stainless steel plate is often selected for the metal plate, grades 304, 316 and 904 in accordance with ASTM standard being suitable, on account of their good deformability. It is also possible to select low-carbon steel or ultralow-carbon steel, in which case the amount of carbon must be less than 0.3 percent by weight, preferably less than 0.15 percent by weight, more preferably less than 0.05 percent by weight. The quantity of manganese must be less than 1.5 percent by weight, and the quantity of silicon must be less than 0.5 percent by weight. This results in a readily deformable carbon steel. It is also possible to select aluminium plate, for example aluminium from the AA1000 series, such as AA1050, from the AA3000 series, such as 3003 or 3105, from the AA5000 series, such as 5018, 5052, 5182, 5186 or 5754, or from the AA6000 series, such as 6016. In addition, it is possible for the separator plates to be made from titanium.

The pressure P for deforming the plate in the desired way will have to be high when the method is used in the two devices described above, at between 250 and 6000 bar (25 and 600 MPa). For softer materials, such as aluminium, a pressure of between 500 and 1000 bar (50 and 100 MPa) is usually sufficient. For harder metals, a pressure of at least 1000 bar (100 MPa), and preferably a pressure of at least 1500 bar (150 MPa) or even 2000 bar (200 MPa) is required. Obviously, the pressure required is also dependent on the thickness of the separator plate and on how complicated the cross section of the separator plate is.

It is possible for a membrane (not shown) to be placed between the metal plate 1 and the bottom die 5, in order to prevent the separator plate from being contaminated. The membrane may be provided with a coating in order to simultaneously coat the metal plate. On the other hand, it is also possible for a lacquer, a polymer, an electrolyte, glass or a salt to be selected as the fluid. As a result, a coating or the pretreatment for a coating is obtained on the separator plate at the same time as the deformation of the metal plate by means of the method.

FIG. 3 shows an embodiment of a possible pattern for the projecting sections in a separator plate. This pattern is serpentine, with the result that sections which run parallel to one another are formed. FIG. 4 shows a cross section through the pattern shown in FIG. 3.

The repeating pattern of projecting sections has a pitch w. The sections projecting downwards in FIG. 4 have a depth d and a mean width a. The section which lies between the projecting sections has a width b, so that a+b=w. The undeformed part between the projecting sections has a width e and the recessed sections have a planar part of width f. The roundings which adjoin the undeformed part have a rounding radius R3, and the roundings which adjoin the planar part of the projecting sections having a rounding radius R4. The overall serpentine pattern has semicircular transitions with an internal rounding radius R1 and an external rounding radius R2, where R1=R2+a, at the ends of the parallel projecting sections.

In most cases, it will be desirable for the separator plate to be symmetrical on both sides, i.e. for a to be equal to b and for e to be equal to f and for R3 to be equal to R4. In a specific case in which the plate thickness is 0.1 mm and the material is 316 stainless steel, it is selected, for example, for a=b=1 mm and therefore w=2 mm, e=f=0.75 mm, R3=R4=0.1 mm, d=0.25 mm, R2=0.5 mm and R1=1.5 mm. The length of the parallel projecting sections is approximately 250 mm.

It will be clear that it is also possible to select other plate thicknesses, in which context it is preferred to use thicknesses of between 0.05 and 0.4 mm. It is also possible to select other materials, for example (ultra)low-carbon steel, aluminium or titanium. It is also possible for other values to be selected for the parameters a, b, w, d, e, f, R1, R2, R3 and R4 in FIG. 3 and FIG. 4. It is also possible to select a different pattern or a different cross section for the separator plate, for example a more or less sinusoidal cross section or a cross section of the projecting sections which is more or less semicircular.

1. Method for forming a separator plate for a fuel cell, which separator plate has a number of projecting sections, comprising forming the projecting sections in the separator plate by pressing a metal plate onto a die having a number of recessed sections with the aid of a pressurized fluid or by pressing the die onto the metal plate supported by pressurized fluid, the recessed sections in the die corresponding to the projecting sections which are to be formed in the metal plate, in order to obtain the separator plate having the projecting sections.

2. Method according to claim 1, wherein the pressure of the fluid is selected to be sufficiently high for the metal plate to be pressed onto the die over its entire surface.

3. Method according to claim 1, wherein a calibration pressure is selected for the pressure of the fluid.

4. Method according to claim 1, wherein the pressure of the fluid is selected to be between 250 and 6000 bar (25 and 600 MPa).

5. Method according to claim 1, wherein the metal plate is first placed against the die, and the metal plate is then pressed onto the die by the pressurized fluid.

6. Method according to claim 1, wherein the metal plate is first placed under a preliminary pressure by the fluid, and then the die is pressed onto the metal plate and the fluid is pressurized.

7. Method according to claim 1, wherein a membrane is placed between the metal plate and the fluid.

8. Method according to claim 1, wherein the metal plate is made from a readily deformable metal.

9. Method according to claim 8, wherein the readily deformable metal has a deformability corresponding to a uniform elongation at break of at least 20%.

10. Method according to claim 1, wherein the plate is at room temperature during the pressing operation.

11. Method according to claim 1, wherein the plate is at elevated temperature during the pressing operation.

12. Method according to claim 1, wherein the thickness of the metal plate prior to the deformation is selected to be between 0.05 and 0.40 mm.

13. Method according to claim 1, wherein at the same time as the projecting sections are being pressed into the metal plate, the metal plate is cut into a desired shape and size.

14. Separator plate having a number of projecting sections, produced using the method of claim 1, wherein the separator plate is formed from a readily deformable metal plate.

15. Separator plate according to claim 14, wherein the readily deformable metal has a deformability corresponding to a uniform elongation at break of at least 20%.

16. Separator plate according to claim 14, wherein the thickness of the separator plate is between 0.05 and 0.40 mm, at the undeformed sections of the plate.

17. Separator plate according to claim 14, wherein the rounding radius of the transitions in the plate is at least equal to the thickness of the undeformed sections of the plate.

18. Separator plate according to claim 14, wherein the projecting sections have a repeating pattern with a pitch w and a depth d, where 0.03<d/w<1.2, if the plate is deformed at room temperature.

19. Separator plate having a number of projecting sections, wherein the projecting sections are surrounded by a substantially planar section of the separator plate, the projecting sections having a substantially repeating pattern with a pitch w and a depth d, where 0.25<d/w<2.4.

20. Separator plate according to claim 19, wherein the thickness of the separator plate is between 0.05 and 0.40 mm, at the undeformed sections of the plate.

21. Method according to claim 1, wherein the pressure of the fluid is selected to be between 500 and 1000 bar (50 and 100 MPa).

22. Method according to claim 1, wherein the pressure of the fluid is selected to be between 1000 and 6000 bar (100 and 600 MPa).

23. Method according to claim 1, wherein the pressure of the fluid is selected to be between 1500 and 6000 bar (150 and 600 MPa).

24. Method according to claim 1, wherein the pressure of the fluid is selected to be between 2000 and 6000 bar (200 and 600 MPa).

25. Method according to claim 1, wherein a membrane is placed between the metal plate and the fluid, the membrane provided with a coating in order to simultaneously coat the metal plate.

26. Method according to claim 1, wherein the metal plate is made from a readily deformable metal selected from the group consisting of low-carbon steel, ultralow-carbon steel, aluminium, stainless steel or titanium.

27. Method according to claim 1, wherein the plate comprises carbon steel and is at 500-1000° C. during the pressing operation.

28. Method according to claim 1, wherein the plate comprises aluminium and is at 100-550° C. during the pressing operation.

29. Method according to claim 1, wherein the plate comprises stainless steel and is at 600-1300° C. during the pressing operation.

30. Method according to claim 1, wherein the thickness of the metal plate prior to the deformation is selected to be between 0.05 and 0.20 mm.

31. Separator plate having a number of projecting sections, produced using the method of claim 1, wherein the separator plate is formed from a readily deformable metal plate made from a member of the group consisting of low-carbon-steel, ultralow-carbon steel, aluminium, stainless steel and titanium.

32. Separator plate according to claim 14, wherein the thickness of the separator plate is between 0.05 and 0.20 mm at the undeformed sections of the plate.

33. Separator plate according to claim 14, wherein the projecting sections have a repeating pattern with a pitch w and a depth d, where 0.1<d/w<0.5 if the plate is deformed at room temperature.

34. Separator plate according to claim 14, wherein the projecting sections have a repeating pattern with a pitch w and a depth d, where 0.2<d/w<0.5 if the plate is deformed at room temperature.

35. Separator plate according to claim 14, wherein the projecting sections have a repeating pattern with a pitch w and a depth d, where 0.03<d/w<2.4 if the plate is deformed at high temperature.

36. Separator plate according to claim 14, wherein the projecting sections have a repeating pattern with a pitch w and a depth d, where 0.2<d/w<1.0 if the plate is deformed at high temperature.

37. Separator plate according to claim 14, wherein the projecting sections have a repeating pattern with a pitch w and a depth d, where 0.4<d/w<1.0 if the plate is deformed at high temperature.

38. Separator plate according to claim 19, wherein the thickness of the separator plate is between 0.05 and 0.20 mm at the undeformed sections of the plate.
